(19) United States
(12) Patent Application Publication
(10) Pub. No.: US 2019/0073659 A1
(43) Pub. Date: Mar. 7, 2019

(54) PRE-ORDER PROCESSING DEVICE

(71) Applicant: TOSHIBA TEC KABUSHIKI KAISHA, Tokyo (JP)

(72) Inventor: Takahiro YAMASHITA, Kurume Fukuoka (JP)

(21) Appl. No.: 16/120,414

(22) Filed: Sep. 3, 2018

(30) Foreign Application Priority Data
Sep. 4, 2017 (JP) 2017-169585

(51) Int. Cl. G06Q 20/20; G06Q 20/28

(52) U.S. Cl. CPC G06Q 20/209; G06Q 20/28; G06Q 20/208

(57) ABSTRACT

A pre-order processing device includes an input device, a scanner, a printer, and a processor. The processor is configured to control the printer to print a pre-order receipt for a pre-order item according to inputs made on the input device, a commodity code read by the scanner, and information about the pre-order item stored in a database.

### CROSS-REFERENCE TO RELATED APPLICATION

This application is based upon and claims the benefit of priority from Japanese Patent Application No. 2017-169585, filed in Sep. 4, 2017, the entire contents of which are incorporated herein by reference.

### FIELD

Embodiments described herein relate generally to a pre-order processing device that is configured to process pre-orders more efficiently and with less errors.

### BACKGROUND

It is common for a retail store to accept from a customer a pre-order for a commodity such as a Christmas cake. In such pre-order sales, a store clerk who has accepted the orders needs to record the sales on a pre-order book and manage it manually.

For this reason, the store clerk has to take much time and labor, and there are possibilities of human errors. Additionally, same situations may happen in providing novelties or free samples in the retail store.

Under these circumstances, there is a need for a method that allows a store clerk to more easily and appropriately manage store transactions such as pre-order sales.

### BRIEF DESCRIPTION OF THE DRAWINGS

FIG. 1 is a block diagram illustrating a schematic configuration of a POS system and circuit configurations of main portions of a POS terminal and a POS server according to an embodiment;

FIG. 2 is a diagram illustrating a configuration of data record included in a pre-order master table shown in FIG. 1;

FIG. 3 is a diagram illustrating a configuration of a data record DR included in the pre-order sales data shown in FIG. 1;

FIG. 4 is a flowchart depicting an information processing by a processor of the POS terminal in FIG. 1;

FIG. 5 is a flowchart depicting the information processing by the processor of the POS terminal in FIG. 1;

FIG. 6 is a diagram illustrating a pick-up date input screen;

FIG. 7 is a diagram illustrating a reception screen;

FIG. 8 is a diagram illustrating a commodity error screen;

FIG. 9 is a diagram illustrating a period error screen;

FIG. 10 is a diagram illustrating a pick-up date error screen;

FIG. 11 is a diagram illustrating an example of a pre-order receipt;

FIG. 12 is a diagram illustrating an example of a pre-order duplicate receipt;

FIG. 13 is a flowchart depicting an information processing by the processor of the POS terminal in FIG. 1;

FIG. 14 is a diagram illustrating an example of a cancellation receipt;

FIG. 15 is a diagram illustrating an example of a cancellation duplicate receipt; and

FIG. 16 is a flowchart depicting an information processing by a processor of the POS server in FIG. 1.

### DETAILED DESCRIPTION

In accordance with an embodiment, a pre-order processing device includes an input device, a scanner, a printer, and a processor. The processor is configured to control the printer to print a pre-order receipt for a pre-order item according to inputs made on the input device, a commodity code read by the scanner, and information about the pre-order item stored in a database.

Hereinafter, embodiments of the invention are described with reference to the accompanying drawings. In an embodiment, a Point-Of-Sale (POS) system, which has a function of a data management system and includes a POS terminal having a function as a data processing apparatus and a POS server having a function as a data management apparatus, is described as an example.

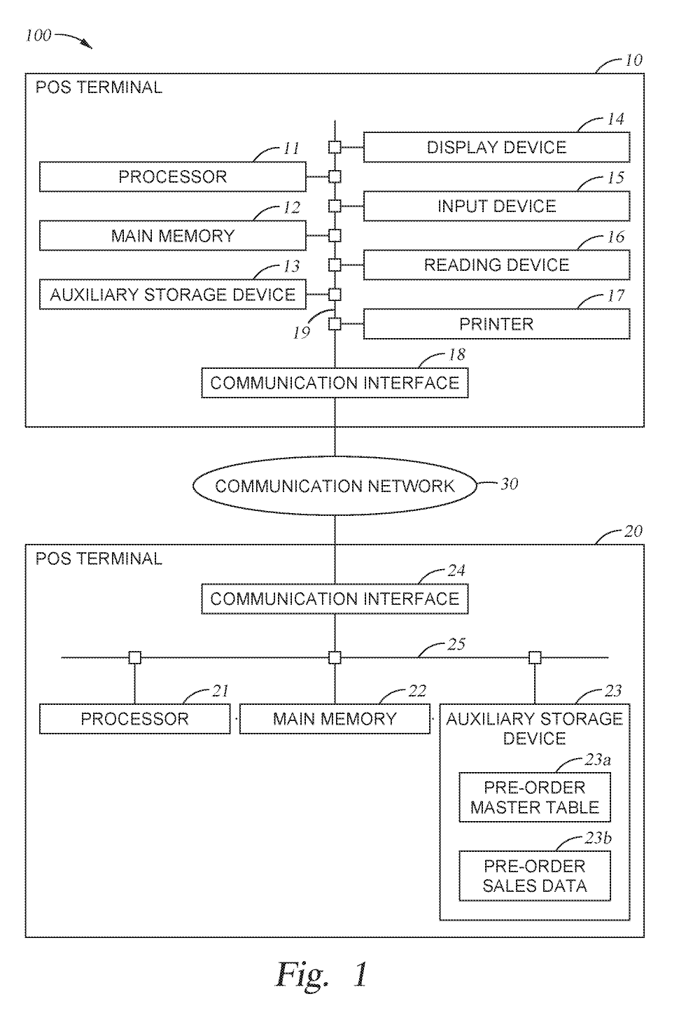

FIG. 1 is a block diagram illustrating a schematic configuration of a POS system 100 and circuit configurations of main portions of a POS terminal 10 and a POS server 20 according to an embodiment.

In the POS system 100, the POS terminal 10 and the POS server 20 can communicate with each other via a communication network 30. The POS system 100 typically includes a plurality of POS terminals 10, but only one POS terminal 10 is shown in FIG. 1.

The POS terminal 10 registers the contents of any transaction such as a sale of an article, provision of food and drink, provision of a service, etc., and further performs a settlement processing. The POS terminal 10 is installed in a retail store where pre-order sales may be performed. A main operator of the POS terminal 10 is a store clerk in the retail store, but the POS terminal 10 may also be operated by a customer. In the embodiments discussed below, it is assumed that the store clerk operates the POS terminal 10.

The POS server 20 manages data of transactions made via the POS terminal 10, as journal data. The POS server 20 may be either a store server provided in each retail store or a headquarters server provided in head office that collectively supervises a plurality of retail stores.

The communication network 30 can use the Internet, a Virtual Private Network (VPN), a Local Area Network (LAN), a public communication network, a mobile communication network or the like alone or in a combined manner. The communication network 30 is typically the LAN or a combination of the LAN and the VPN.

The POS terminal 10 includes a processor 11, a main memory 12, an auxiliary storage device 13, a display device 14, an input device 15, a reading device 16, a printer 17, a communication interface 18 and a transmission path 19.

The processor 11, the main memory 12 and the auxiliary storage device 13 in the POS terminal 10 are connected with each other through the transmission path 19 to constitute a computer for performing an information processing for controlling the POS terminal 10.

The processor 11 acts as a central part of the computer. The processor 11 controls each section to realize various functions of the POS terminal 10 by executing an operating system and an application program.

The main memory 12 includes a non-volatile memory area and a volatile memory area. The main memory 12 stores the operating system and the application program in the non-volatile memory area. The main memory 12 stores data necessary for the processor 11 to execute a processing for controlling each section in the non-volatile or volatile memory area in some cases. The main memory 12 uses the volatile memory area as a work area where data is appropriately rewritten by the processor 11.

The auxiliary storage device 13 acts as an auxiliary storage section of the computer. The auxiliary storage device 13 is, for example, an Electric Erasable Programmable Read-Only Memory (EEPROM), a Hard Disk Drive (HDD), a Solid State Drive (SSD), or other well-known storage devices. The auxiliary storage device 13 stores data used for the processor 11 to execute various processing and data generated in the processing by the processor 11. The auxiliary storage device 13 stores the application program in some cases.

The display device 14 displays various screens for notifying an operator of various information. For example, a well-known device such as a liquid crystal display device may be provided as the display device 14.

An operator inputs various instructions with the input device 15. The input device 15 can use a well-known device such as a touch sensor and a keyboard alone or in a combined manner. The input device 15 has a pre-order process key. The pre-order process key is operated by the operator when the operator wants to operate the POS terminal 10 in a mode for receiving a pre-order of a commodity. The pre-order process key may be a hardware key provided on the above keyboard or a Graphical User Interface (GUI) displayed on a touch panel.

The reading device 16 reads at least one of data displayed on a commodity and data stored in a storage medium. As the reading device 16, well-known devices such as a barcode scanner, a wireless tag reader or a card reader may be used alone or in a combined manner.

The printer 17 prints images of various vouchers on a receipt paper and issues various vouchers.

The communication interface 18 performs data communication via the communication network 30. As the communication interface 18, for example, a well-known device which can perform a well-known processing for data communication via the LAN and the Internet can be used.

The transmission path 19 includes an address bus, a data bus, a control signal line, and the like, and transmits data and control signals transmitted and received between the connected sections.

The POS terminal 10 stores application programs in the main memory 12 or the auxiliary storage device 13 to implement the information processing method described later. The information processing program may be stored in the main memory 12 or the auxiliary storage device 13 at the time of transfer of the hardware of the POS terminal 10 or may be transferred separately from the above hardware. In the latter case, the information processing method is recorded in a removable recording medium such as a magnetic disk, a magneto-optical disk, an optical disk, a semiconductor memory, etc., or is transferred via the network.

The POS server 20 includes a processor 21, a main memory 22, an auxiliary storage device 23, a communication interface 24 and a transmission path 25. The processor 21, the main memory 22, the auxiliary storage device 23 and the communication interface 24 are connected with each other through the transmission path 25.

In the POS server 20, the processor 21, the main memory 22, and the auxiliary storage device 23 are connected with each other through the transmission path 25 to constitute a computer that performs an information processing for controlling the POS server 20.

The processor 21 acts as a central part of the computer. The processor 21 controls each section to realize various functions of the POS server 20 by executing an operating system and an application program.

The main memory 22 includes a non-volatile memory area and a volatile memory area. The main memory 22 stores the operating system and the application program in the non-volatile memory area. The main memory 22 stores data necessary for the processor 21 to execute a processing for controlling each section in the non-volatile or volatile memory area in some cases. The main memory 22 uses the volatile memory area as a work area where data is appropriately rewritten by the processor 21.

The auxiliary storage device 23 acts as an auxiliary storage section of the computer. The auxiliary storage device 23 is, for example, an EEPROM, a HDD, a SSD, or other well-known storage devices. The auxiliary storage device 23 stores data used for the processor 21 to execute various processing and data generated in the processing by the processor 21. The auxiliary storage device 23 stores the application program in some cases.

The communication interface 24 performs data communication via the communication network 30. As the communication interface 24, for example, a well-known device which can perform a well-known processing for data communication via the Internet can be used.

The transmission path 25 includes an address bus, a data bus, a control signal line, and the like, and transmits data and control signals transmitted and received between the connected sections.

A part of the storage area of the auxiliary storage device 23 stores a pre-order master table 23a and a pre-order sales data 23b. The pre-order master table 23a contains various information for managing pre-order sales. The pre-order sales data 23b contains various information for managing the performance of the pre-order sales.

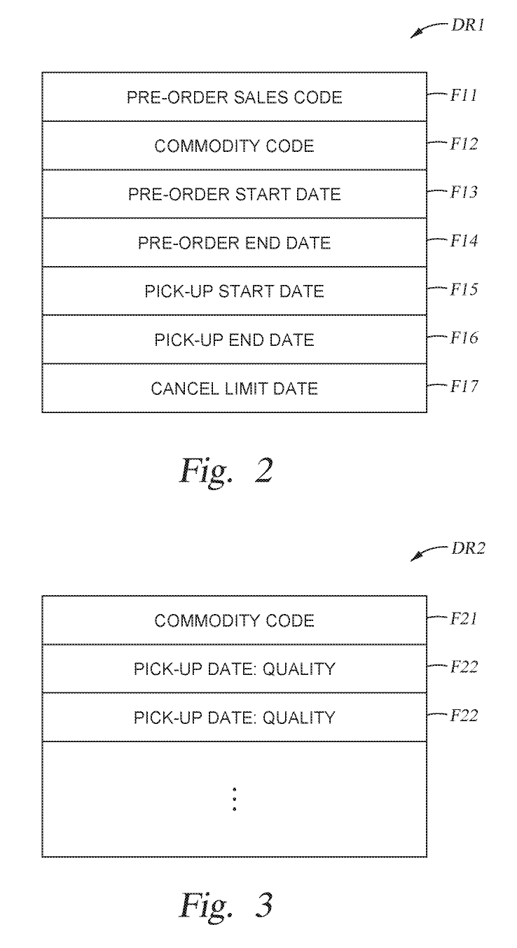

FIG. 2 is a diagram illustrating a configuration of a data record DR1 contained in the pre-order master table 23a.

The pre-order master table 23a is a set of a plurality of data records DR1. However, the pre-order master table 23a may be standardized by a well-known method without containing the data record DR1 shown in FIG. 2 without any change.

The data record DR1 corresponds to one pre-order sales transaction. The data record DR1 includes fields F11, F12, F13, F14, F15, F16, and F17. The data in the field F11 indicates a pre-order sales code which is an identification code for identifying the corresponding pre-order sales transaction. The data in the field F12 indicates a commodity code which is an identification code for identifying a commodity which is a target of the pre-order sales. The data in the fields F13 and F14 indicates start and end dates of a period during which the pre-order in the corresponding pre-order sales transaction can be received. The data in fields F15 and F16 indicates start and end dates of a period during which a pre-ordered commodity can be picked up by a customer in the corresponding pre-order sales transaction. The data in the field F17 indicates a deadline before which the pre-order already made in the corresponding pre-order sales transaction can be canceled.

FIG. 3 is a diagram illustrating a configuration of a data record DR2 contained in the pre-order sales data 23b.

The pre-order sales data 23b is a set of a plurality of data records DR2. However, the pre-order sales data 23b may be standardized by a well-known method without containing a plurality of data records shown in FIG. 3 without any change.

The data record DR2 corresponds to each commodity. The data record DR2 includes a field F21 and at least one field F22. The data in the field F21 indicates a commodity code of the corresponding commodity. The data in the field F22 indicates a pick-up date and quantity in an associated manner. The quantity indicates a total number of the pre-ordered commodities to be picked up at the associated pick-up date. Thus, the data record DR2 includes the fields F22 the number of which is the same as the number of actual pick-up dates in the pre-order for the corresponding commodity.

The POS server 20 is realized by, for example, a general-purpose computer in which the information processing program for realizing the later-described information processing as one of application programs is written into the main memory 22 or the auxiliary storage device 23. The information processing program may be stored in the main memory 22 or the auxiliary storage device 23 at the time of transfer of the POS server 20 or may be transferred separately from the above-described general-purpose computer. In the latter case, the information processing program is transferred by using a removable recording medium such as a magnetic disk, a magneto-optical disk, an optical disk, a semiconductor memory, etc., or is transferred via a network.

Next, the operation of the POS system 100 configured as described above is described. The content of various processing described below is merely an example, and various processing capable of achieving the same result can be appropriately used.

First, when there is a new pre-order sales transaction, a person responsible for managing the pre-order sales accesses the POS server 20 from an information terminal, and designates a commodity code of a target commodity, a pre-order start date, a pre-order end date, a pick-up start date and a pick-up end date in the pre-order sales transaction. Then, in the POS server 20, the processor 21 determines a pre-order sales code different from the pre-order sales code already shown in the field F11 of the data record DR1 in the pre-order master table 23a. Then, the processor 21 adds the new data record DR1 to the pre-order master table 23a. The processor 21 displays the above pre-order sales code, the commodity code, pre-order start date, the pre-order end date, the pick-up start date and the pick-up end date inputted above in the fields F11 to F16 of the new data record DR1.

The POS terminal 10 has a function of performing a registration processing and a checkout processing on a purchase commodity in a regular sales transaction, which is the same as the existing device. Then, while waiting for the start of a processing relating to a new transaction, if the depression of the pre-order process key is detected by the input device 15, the processor 11 starts an information processing described below. The processor 11 executes the information processing described below by executing the information processing program stored in the main memory 12 or the auxiliary storage device 13.

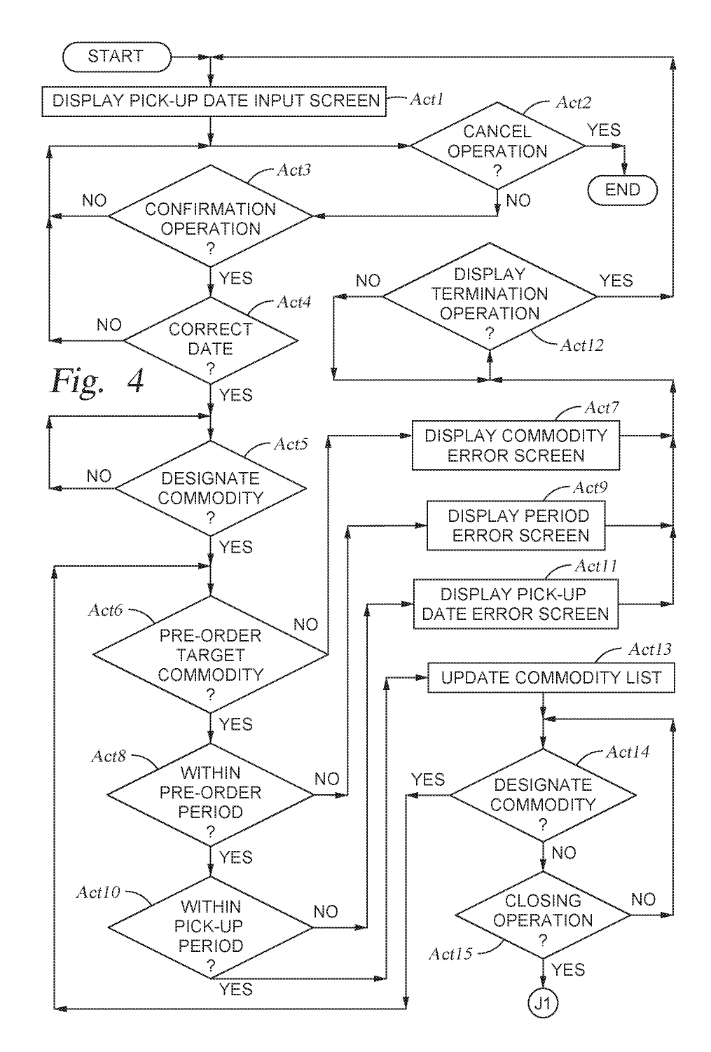

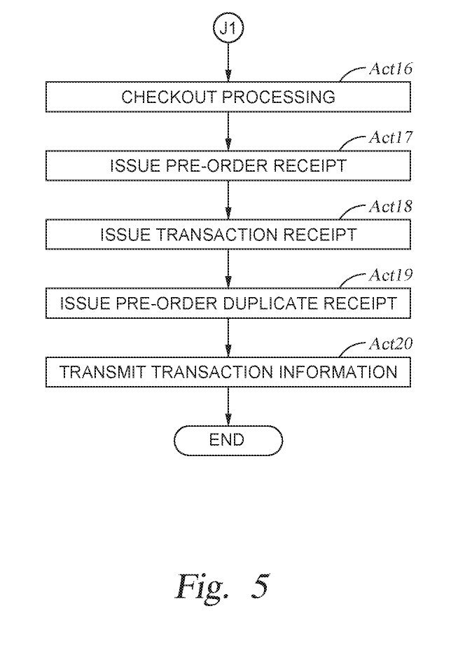

FIG. 4 and FIG. 5 are flowcharts depicting the information processing by the processor 11.

In Act 1, the processor 11 displays a pick-up date input screen SC1 on the display device 14. The pick-up date input screen SC1 is used for a store clerk to input a pick-up date as a date at which a customer desires to receive the commodity.

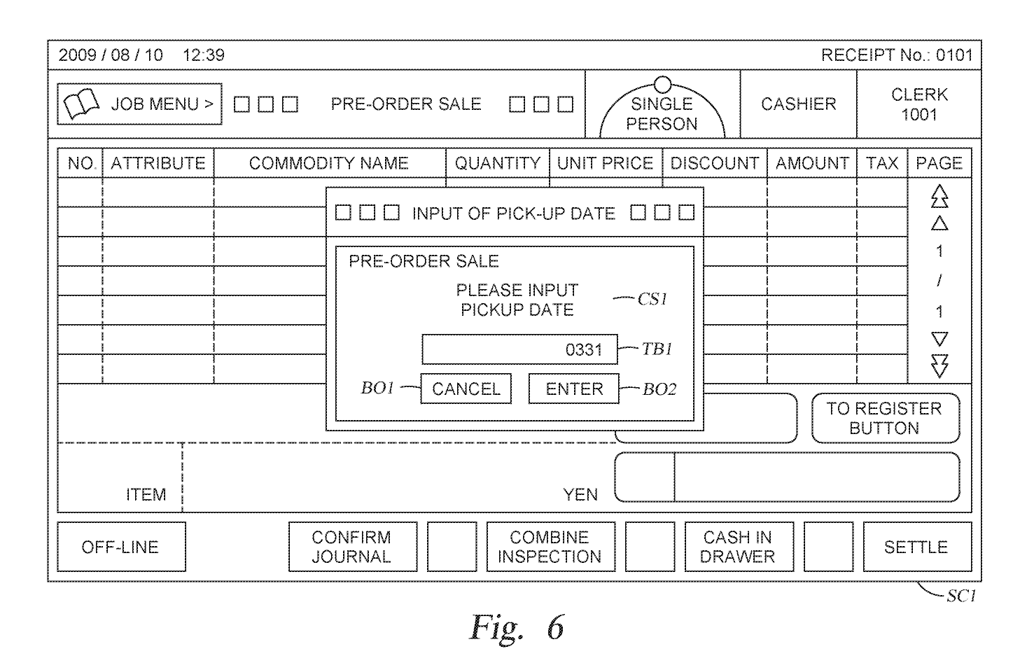

FIG. 6 is a diagram illustrating the pick-up date input screen SC1.

A character string CS1, a text box TB1 and buttons BO1 and BO2 are shown on the pick-up date input screen SC1.

The character string CS1 indicates a character message for promoting the store clerk to input the pick-up date. The text box TB1 is an input field for receiving an input of the pick-up date. The button BO1 is a GUI for a store clerk to cancel the pre-order process. The button BO2 is a GUI for a store clerk to confirm the input pick-up date.

In FIG. 6, there is shown a state in which numeral values for designating “March 31st” as the pick-up date, and “0331” is shown in the text box TB1. The “0331” is not shown when the processor 11 executes the processing in Act 1. The processor 11 proceeds to the processing in Act 2 while the pick-up date input screen is displayed.

In Act 2, the processor 11 determines whether or not a cancellation operation is performed. Then, if the corresponding operation is not performed, the processor 11 determines No, and proceeds to the processing in Act 3.

In Act 3, the processor 11 determines whether or not a confirmation operation is performed. Then, if the corresponding operation is not performed, the processor 11 determines “No” and returns to the processing in Act 2. Thus, the processor 11 stands by until the cancellation operation in Act 2 or the confirmation operation in Act 3 is performed.

If the store clerk cancels the reception of the pre-order for some reason, for example, the store clerk performs the cancellation operation such as touching the button BO1. Then, the processor 11 determines Yes in Act 2 and terminates the information processing shown in FIG. 4.

On the other hand, the store clerk asks the customer about his or her desired pick-up date of the commodity to input the pick-up date in the text box TB1. Then, the store clerk performs the confirmation operation such as touching the button BO2. Then, the processor 11 determines Yes in Act 3 and proceeds to the processing in Act 4.

In Act 4, the processor 11 determines whether or not the information input in the text box TB1 correctly indicates the date. If the information does not correctly indicate the date, the processor 11 determines No and returns to the standby state in Act 2 and Act 3.

On the other hand, if the information input in the text box TB1 correctly indicates the date, the processor 11 determines Yes in Act 4 and proceeds to the processing in Act 5. At this time, the processor 11 terminates the display of the pick-up date input screen SC1, and changes the display on the display device 14 to a reception screen SC2 for receiving designation of the commodity. Here, the processor 11 inputs the future date input above as the pick-up date when the customer can pick up the pre-ordered commodity.

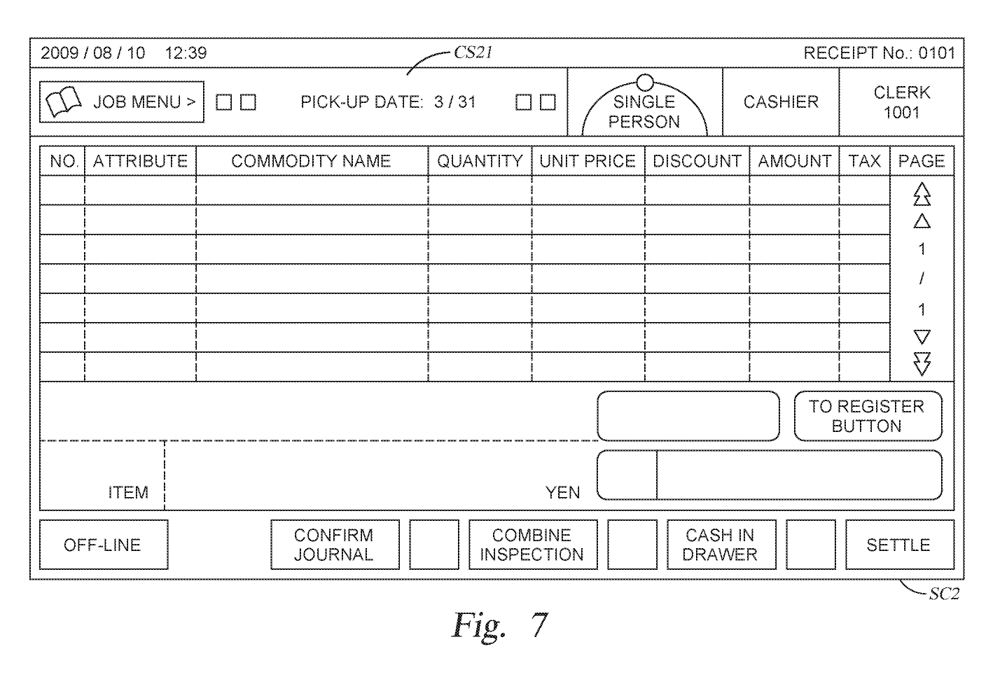

FIG. 7 is a diagram illustrating the reception screen SC2.

The reception screen SC2 may be the same as a screen displayed on the display device 14 at the time of normal purchase registration. However, the reception screen SC2 includes a character string CS21 in such a manner that the store clerk can recognize that the pre-order can be received for the pre-order sales on the pick-up date designated as described above. The character string CS21 indicates the pre-order can be received for the pre-order sales with “March 31st” as the pick-up date. In other words, the reception screen SC2 shown in FIG. 7 shows an example in which “March 31st” is designated as the pick-up date.

In Act 5, the processor 11 stands by until a commodity is designated. At this time, the store clerk designates the commodity through a well-known operation such as reading the barcode displayed on the commodity using the reading device 16, for example. If the commodity is designated in this manner, the processor 11 determines Yes in Act 5 and proceeds to the processing in Act 6. At this time, the processor 11 acquires the commodity code of the designated commodity.

In Act 6, the processor 11 determines whether or not the designated commodity is a target commodity for which the pre-order is received. Specifically, the processor 11 determines whether or not the data record DR1 in which the data in the field F12 indicates the commodity code of the designated commodity is included in the pre-order master table 23a. The processor 11 copies the pre-order master table 23a in the main memory 12 or the auxiliary storage device 13 from the POS server 20 at a predetermined timing such as when the POS terminal 10 is started or when the pre-order master table 23a is updated. Then, the processor 11 refers to the pre-order master table 23a stored in the main memory 12 or the auxiliary storage device 13 in this way to perform the above determination. However, the processor 11 may make an inquiry to the POS server 20 each time the above determination is performed without copying the pre-order master table 23a. Then, if the corresponding data record DR1 is not found, the processor 11 determines No, and proceeds to the processing in Act 7.

In Act 7, the processor 11 displays a commodity error screen SC3 on the display device 14. The commodity error screen SC3 is used for informing the store clerk that the designated commodity is not the target of the reservation sales.

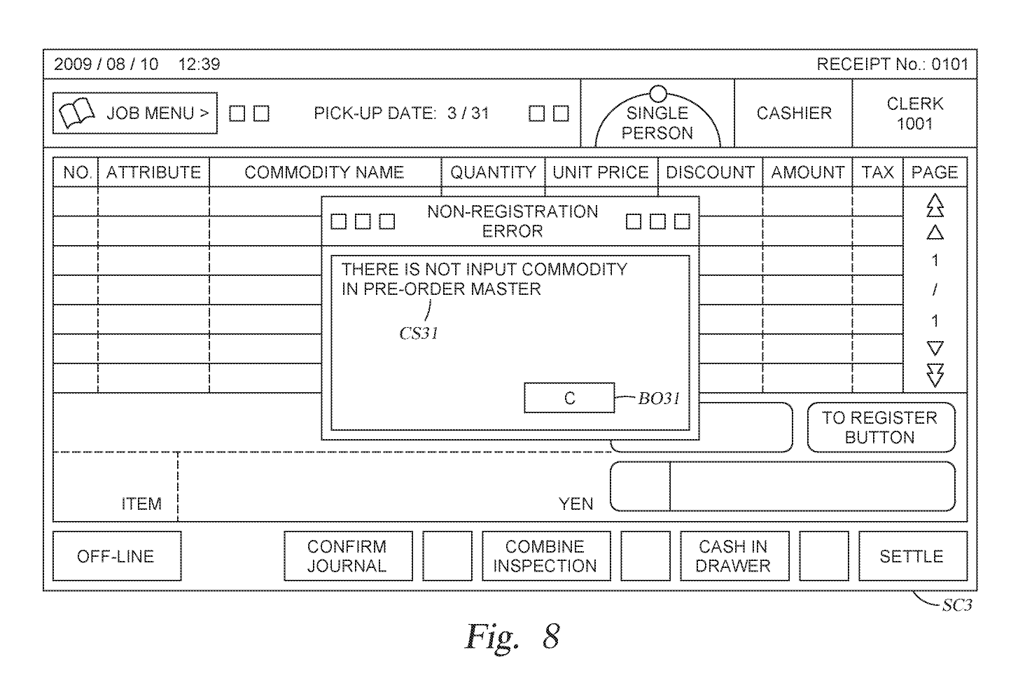

FIG. 8 is a diagram illustrating the commodity error screen SC3.

A character string CS31 and a button BO31 are shown on the commodity error screen SC3.

The character string CS31 indicates a character message indicating that the designated commodity is not the target of the reservation sales. The button BO31 is a GUI for the store clerk to confirm the display termination of the commodity error screen SC3.

On the other hand, if the corresponding data code DR1 is found in Act 6, the processor 11 determines Yes and proceeds to the processing in Act 8. Hereinafter, the data record DR1 found by the processor 11 is referred to as a commodity coincidence record. The pre-order sales for the same commodity may be performed more than once, and in this case, the pre-order master table 23a includes a plurality of data records DR1 in which the data in the fields F12 indicates the same commodity code. Therefore, the processor 11 may find a plurality of commodity coincidence records.

In Act 8, the processor 11 determines whether or not the current date falls within the pre-order period of the designated commodity. Specifically, if the current date is within a period from the pre-order start date indicated by the data in the field F13 to the pre-order end date indicated by the data of the field F14 in the commodity coincidence record, the processor 11 determines the current date is within the pre-order period. If there are plural commodity coincidence records, the processor 11 determines that the current date is within the pre-order period if one of the plural commodity coincidence records satisfies the above condition. If the processor 11 determines that the current date is not within the pre-order period, the processor 11 determines No in Act 8, and proceeds to the processing in Act 9.

In Act 9, the processor 11 displays a period error screen SC4 on the display device 14. The period error screen SC4 is used for informing the store clerk that the current date is not within the period during which the pre-order of the designated commodity can be received.

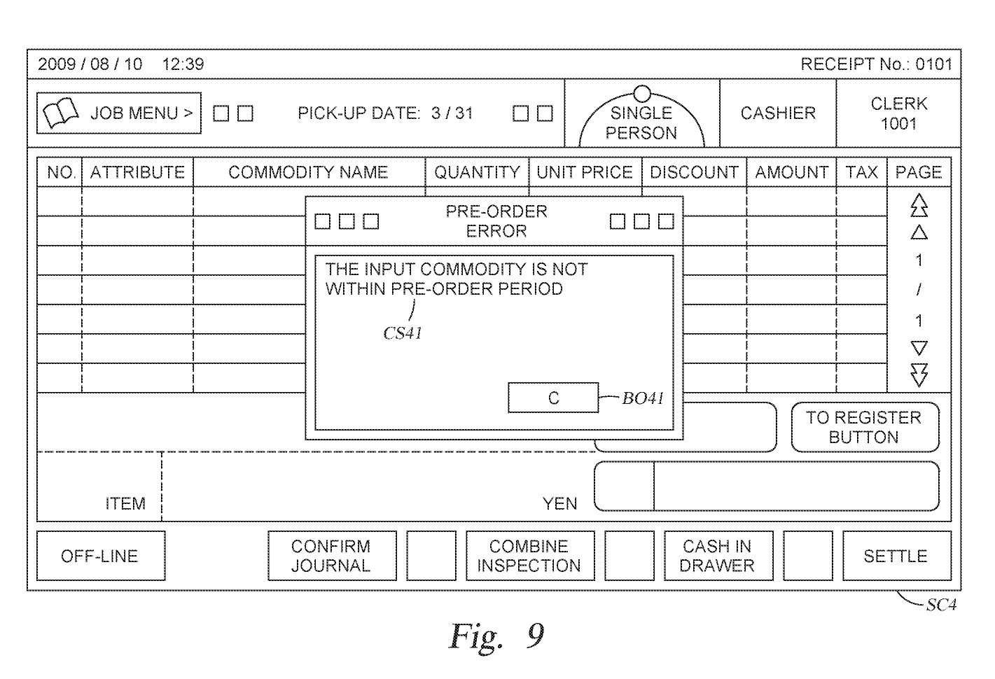

FIG. 9 is a diagram illustrating the period error screen SC4.

A character string CS41 and a button BO41 are shown on the period error screen SC4.

The character string CS41 indicates a character message indicating that the current time point is not within a period during which the pre-order of the designated commodity can be received. The button BO41 is a GUI for the store clerk to confirm the termination of display of the period error screen SC4.

On the other hand, if the processor 11 determines that the current time point is within the pre-order period, the processor 11 determines Yes in Act 8 and proceeds to the processing in Act 10. Here, the commodity coincidence record referred to in order to determine that the processor 11 is within the pre-order period is referred to as a period coincidence record in the following description. If there are plural commodity coincidence records, it is assumed that the pre-order periods indicated therein partially overlap. In this case, it is assumed that the current date is within the overlapping period. Therefore, the processor 11 may find a plurality of period coincidence records.

In Act 10, the processor 11 determines whether or not the pick-up date input in the standby state in Act 2 and Act 3 is within a pick-up period of the designated commodity. Specifically, if the pick-up date is within a period from the pick-up start date indicated by the data of the field F15 to the pick-up end date indicated by the data of the field F16 in the period coincidence record, the processor 11 determines that the pick-up date is within the pick-up period. If there are plural period coincidence records, the processor 11 determines that the pick-up date is within the pick-up period if one of the plural period coincidence records satisfies the above condition. If it is determined that the pick-up date is not within the pick-up period, the processor 11 determines No in Act 10, and proceeds to the processing in Act 11.

In Act 11, the processor 11 displays a pick-up date error screen SC5 on the display device 14. The pick-up date error screen SC5 is used for informing the store clerk that the designated pick-up date is incorrect as the pick-up period of the designated commodity.

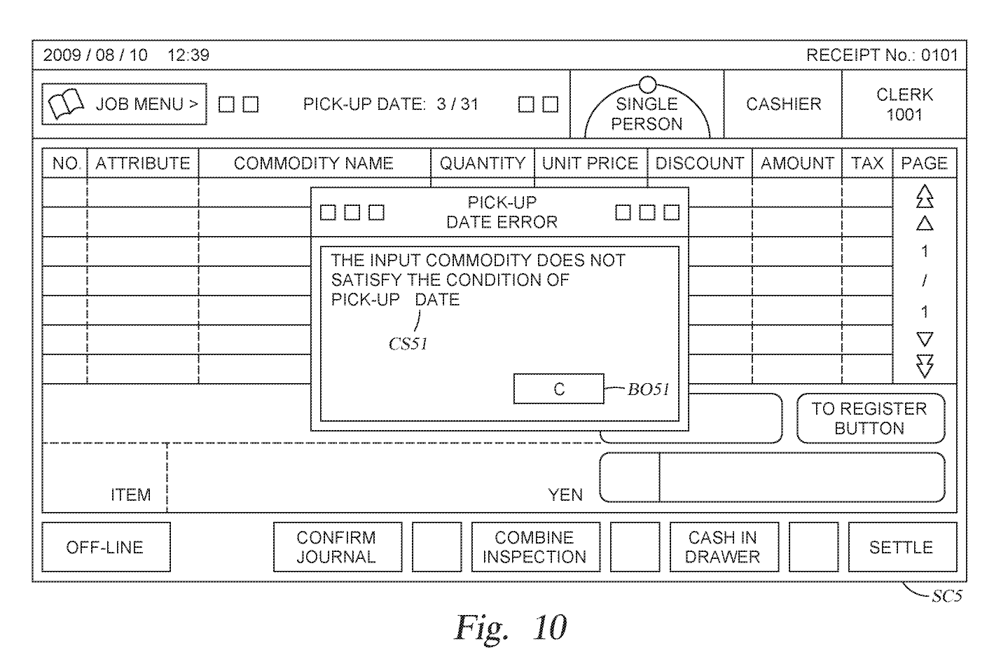

FIG. 10 is a diagram illustrating a pick-up date error screen SC5.

A character string CS51 and a button BO51 are shown on the pick-up date error screen SC5.

The character string CS51 indicates a character message indicating that the designated pick-up date is incorrect as the pick-up date of the designated commodity. The button BO51 is a GUI for the store clerk to confirm the termination of display of the pick-up date error screen SC5.

If any one of the commodity error screen SC3 in Act 7, the period error screen SC4 in Act 9 and the pick-up date error screen SC5 in Act 11 is displayed, the processor 11 proceeds to the processing in Act 12.

In Act 12, the processor 11 stands by until an operation of confirming the termination of display of the screen being displayed is performed. At this time, if the store clerk finishes the confirmation of the commodity error screen SC3, the period error screen SC4 or the pick-up date error screen SC5, the store clerk performs a display termination operation such as touching the button B31, the button B41 or the button B51. Accordingly, the processor 11 determines Yes in Act 12 and returns to the processing in Act 1. In other words, the processor 11 starts the processing again from the input of the pick-up date.

In this way, if the commodity cannot be picked up by the customer at the pick-up date, the processor 11 performs an informing processing for displaying the commodity error screen, the period error screen or the pick-up date error screen on the display device to inform that fact.

If it is determined that the input pick-up date is within the pick-up period, the processor 11 determines Yes in Act 10, and proceeds to the processing in Act 13.

In Act 13, the processor 11 updates a commodity list to include the commodity code of the designated commodity. The commodity list is stored in the main memory 12 or the auxiliary storage device 13, and is cleared by the processor 11 at the start of the information processing or the like.

In Act 14, the processor 11 determines whether or not a new commodity is designated. Then, if no commodity is designated, the processor 11 determines No in Act 14, and proceeds to the processing in Act 15.

In Act 15, the processor 11 determines whether or not a closing operation is performed. If the corresponding operation is not performed, the processor 11 determines No in Act 15, and returns to the processing in Act 14.

Thus, the processor 11 stands by until the new commodity designation in Act 14 or the closing operation in Act 15 is performed. At this time, the store clerk designates an undesignated commodity if the same customer wants to pre-order plural commodities. If the new commodity is designated in this manner, the processor 11 determines Yes in Act 14 and returns to the processing in Act 6. At this time, the processor 11 acquires the commodity code of the designated commodity. In other words, the processor 11 repeats the processing subsequent to Act 6 for the new designated commodity in the same manner as described above.

After finishing the designation of all of the commodities to be pre-ordered, the store clerk performs a predetermined closing operation such as pressing a subtotal key provided on the input device 15. Then, the processor 11 determines Yes in Act 15 and proceeds to the processing in Act 16 in FIG. 5.

In Act 16, the processor 11 calculates payment out for the purchase commodity based on the commodity list, inputs an amount deposited from the customer, and performs a checkout processing for settling the payment amount. In this case, the sale of the commodity may be treated as a credit sale without performing settlement.

In Act 17, the processor 11 enables the printer 17 to issue a pre-order receipt. The pre-order receipt is handed over to the customer as a certificate of pre-order. Specifically, the processor 11 generates an image indicating a pre-order result such as the pick-up date and the content of the commodity list, and instructs the printer 17 to print the image.

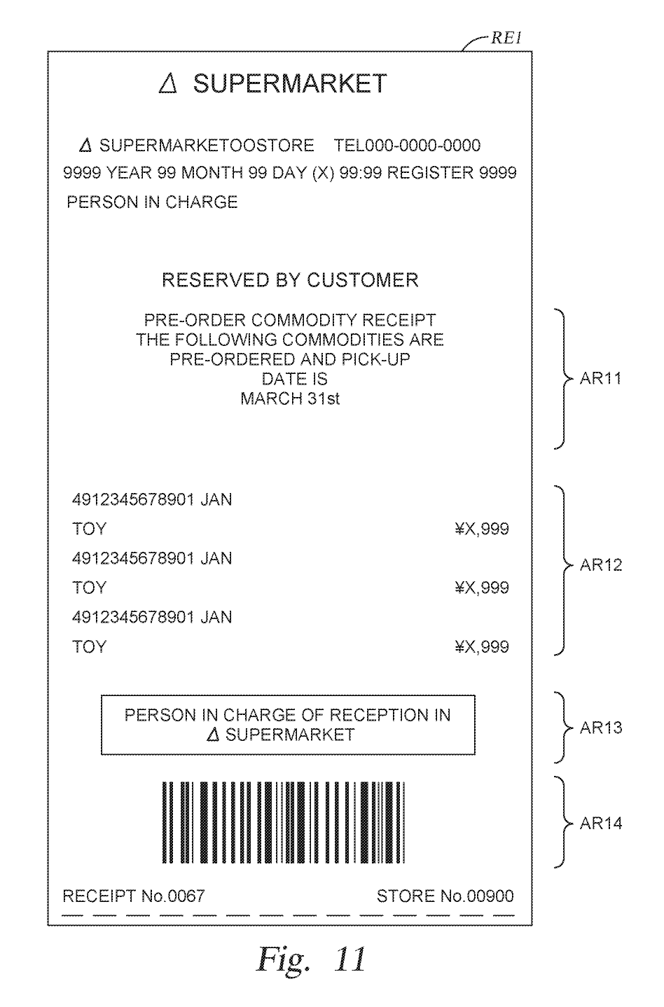

FIG. 11 is a diagram illustrating an example of a pre-order receipt RE1. FIG. 11 shows a form of the pre-order receipt RE1, and a part of the shown information is different from the actual one.

An area AR11 in the pre-order receipt RE1 indicates that a pre-order to receive a commodity on March 31st which is the designated pick-up date is performed. An area AR12 in the pre-order receipt RE1 shows contents of the commodity list, i.e., a catalog of pre-ordered commodities. An area AR13 in the pre-order receipt RE1 indicates a signature column for signing by a store clerk who receives the pre-order by operating the POS terminal 10. An area AR14 of the pre-order receipt RE1 indicates a barcode for journal search.

In Act 18, the processor 11 enables the printer 17 to issue a transaction receipt. The transaction receipt is handed over to the customer for confirmation of the content of the transaction, and is the same as a general receipt issued by the existing POS terminal. Specifically, the processor 11 generates an image indicating the transaction result such as the content of the commodity list and the result of the checkout processing, and instructs the printer 17 to print the image.

In Act 19, the processor 11 enables the printer 17 to issue a pre-order duplicate receipt. The pre-order duplicate receipt is kept in the retail store as a certificate indicating that the pre-order is made. Specifically, the processor 11 generates an image indicating the pre-order result such as the pick-up date and the content of the commodity list, and instructs the printer 17 to print the image.

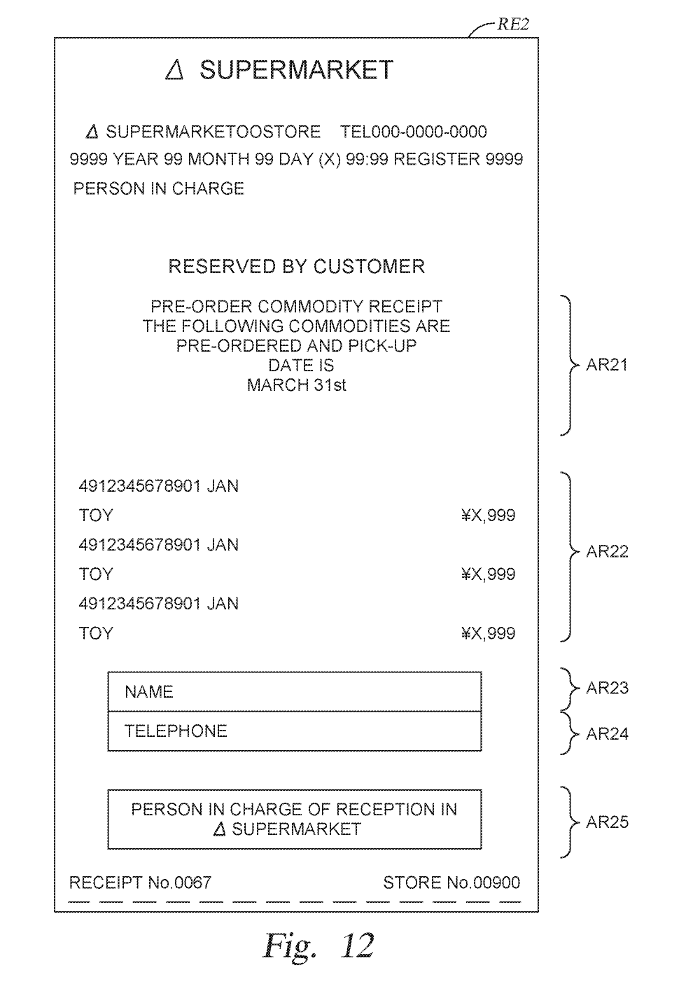

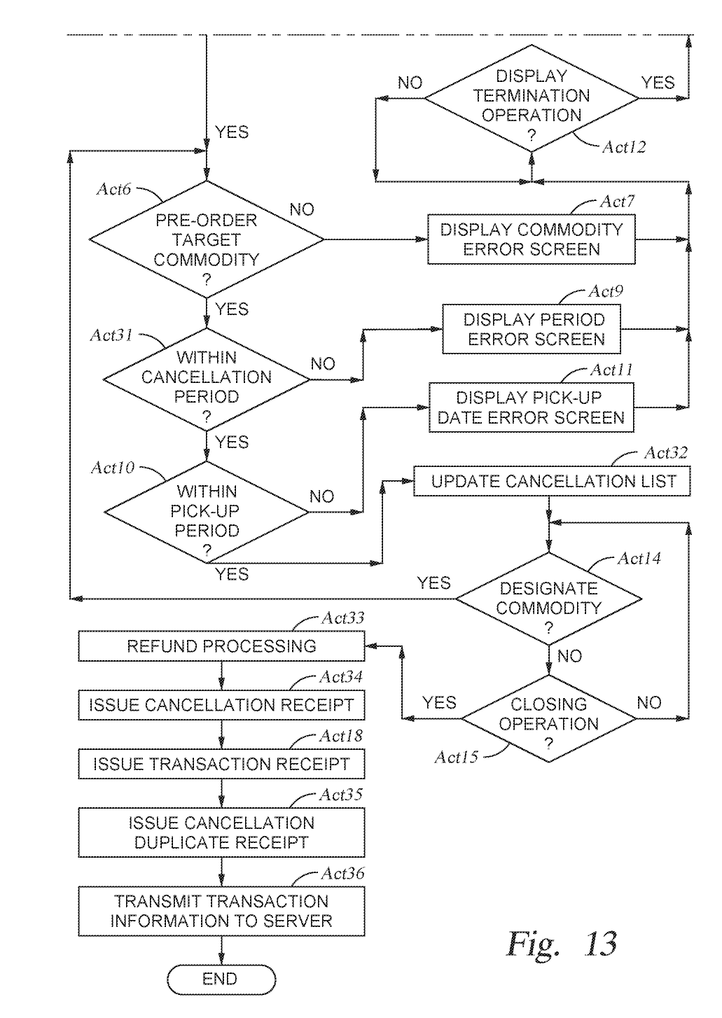

FIG. 12 is a diagram illustrating an example of a pre-order duplicate receipt RE2. FIG. 12 shows a form of the pre-order duplicate receipt RE2, and a part of the shown information is different from the actual one.

The area AR21 in the pre-order duplicate receipt RE2 indicates that a pre-order of a commodity to be picked up on March 31 is made. The area AR22 in the pre-order duplicate receipt RE2 indicates a content of the commodity list, i.e., a catalog of pre-ordered commodities. The area AR23 in the pre-order duplicate receipt RE2 indicates a signature column for signing by the customer who makes the pre-order. The area AR24 in the pre-order duplicate receipt RE2 indicates an entry field for the customer who makes the pre-order to input the telephone number as a contact address. The area AR25 in the pre-order duplicate receipt RE2 indicates a signature column for signing by a store clerk who receives the pre-order by operating the POS terminal 10.

As described above, the pre-order duplicate receipt RE2 corresponds to a pre-order receipt for the retail store as a provider, which indicates that a pre-order is made for the commodity determined as a pre-order target as described above to be picked up on the pick-up date. The pre-order receipt RE1 described above corresponds to a pre-order receipt for a customer as a recipient, which indicates that the pre-order is made. Thus, the processing in Act 19 corresponds to an issuing processing for issuing a pre-order receipt. In other words, the processor 11 executes the information processing based on the information processing program, and in this way, the computer having the processor 11 as the central part functions as an issuing module.

In Act 20, the processor 11 transmits the transaction information to the POS server 20 from the communication interface 18 through the communication network 30. For example, the transaction information may be the same as information transmitted from the existing POS terminal to the POS server for sales management in the existing POS server. However, the processor 11 includes the pick-up date in association with each commodity code in the transaction information. As a result, the pre-order is notified to the POS server 20 by transmission of the transaction information. The processor 11 may store the transaction information in the main memory 12 or the auxiliary storage device 13 and transmit it at a predetermined timing.

After that, the processor 11 terminates the information processing shown in FIG. 4 and FIG. 5.

In the retail store, pre-order information about the customer, the pick-up date and the type of the commodity is managed according to the pre-order duplicate receipt RE2. Then, if the customer brings the pre-order receipt RE1 and goes to the retail store to request cancellation of the pre-order, the customer performs an operation for instructing start of a processing for cancelling the pre-order with the input device 15 while the POS terminal 10 is waiting for the start of a processing relating to the new transaction. Then, the processor 11 starts the information processing described below. The processor 11 executes the information processing described below by executing the above-described information processing program stored in the main memory 12 or the auxiliary storage device 13.

FIG. 13 is a flowchart depicting the information processing by the processor 11. In FIG. 13, processing which is the same as that in the information processing shown in FIG. 4 and FIG. 5 is denoted with the same reference numerals as those in FIG. 4 and FIG. 5, and the detailed description thereof is omitted. In FIG. 13, illustration of the processing in Act 1 to Act 5 is omitted.

At the time of canceling the pre-order, the processor 11 executes the processing in Act 1 to Act 7 in the same manner as the information processing in the case of the reception of the pre-order described above. At this time, the processor 11 acquires the commodity code of a commodity whose pre-order is canceled, and inputs the pick-up date relating to the commodity. Thus, the processor 11 executes the information processing by executing the information processing program, and in this way, the computer having the processor 11 as the central part functions as a second acquisition module for acquiring the commodity code and a second input module for inputting the pick-up date.

Then, since the designated commodity is the pre-order target, the processor 11 determines Yes in Act 6, and proceeds to the processing in Act 31.

In Act 31, the processor 11 determines whether or not the current time point is within a cancellation period during which the pre-order of the designated commodity can be canceled. Specifically, the processor 11 determines that the current time point is within the cancellation period if the current date is earlier than a cancellation deadline indicated by the data in the field F17 in the commodity coincidence record. If there are plural commodity coincidence records, the processor 11 determines that the current time point is within the cancellation period if one of the plural commodity coincidence records satisfies the above condition. If the processor 11 determines that the current time point is not within the cancellation period, the processor 11 determines No in Act 31, and proceeds to the processing in Act 9.

On the other hand, if the processor 11 determines that the current time point is within the cancellation period in Act 31, the processor 11 determines Yes in Act 31, and proceeds to the processing in Act 10. Here, the commodity coincidence record referred to by the processor 11 to determine that the current time point is within the cancellation period is referred to as a period coincidence record in the following description. If there are plural commodity coincidence records, it is assumed that all the cancellation deadlines are later than the current date. Therefore, the processor 11 may find a plurality of period coincidence records.

The processor 11 executes the same processing in Act 10 to Act 12 as that in the information processing in the case of receiving the pre-order described above. However, if it is determined that the pick-up date is within the pick-up period in Act 10, the processor 11 determines Yes in Act 10, and proceeds to the processing in Act 32.

In Act 32, the processor 11 updates a cancellation list to include the commodity code of the designated commodity. The cancellation list is stored in the main memory 12 or the auxiliary storage device 13, and is cleared by the processor 11 at the start of the information processing or the like.

After that, the processor 11 executes the same standby processing in Act 14 and Act 15 as the information processing in the case of receiving the pre-order described above.

Then, if the store clerk performs the closing operation, the processor 11 determines Yes in Act 15, and proceeds to the processing in Act 33.

In Act 33, the processor 11 performs a refund processing. Specifically, the processor 11 calculates the payment amount of the commodity whose pre-order is canceled based on the cancellation list. However, the processor 11 calculates the above-described payment amount in consideration of a selling price of the commodity at this time point. There is a case in which the settled amount at the checkout at the time of pre-order is different from the above payment amount due to difference in the selling prices or application of a discount. Therefore, the processor 11 changes the payment amount to be refunded in response to an operation by the store clerk. In the checkout at the time of pre-order, the processor 11 determines which kind of a settlement method is used to perform the settlement in response to the operation by the store clerk. Then, the processor 11 performs a processing for refunding the payment amount changed as necessary by a refund method according to the settlement method. If the commodity is sold by credit sale at the time of pre-order, the payment amount to be refunded is set to 0. The store clerk confirms the existence of the pre-order to be canceled from the pre-order receipt and the transaction receipt presented by the customer and the pre-order duplicate receipt kept in the retail store, and further refund the appropriate payment amount required to be refunded by the appropriate refund method as described above.

In Act 34, the processor 11 enables the printer 17 to issue the cancellation receipt. The cancellation receipt is handed over to the customer as a certificate for cancellation of the pre-order. Specifically, the processor 11 generates an image indicating the canceling result such as the pick-up date and the content of the commodity list, and instructs the printer 17 to print the image.

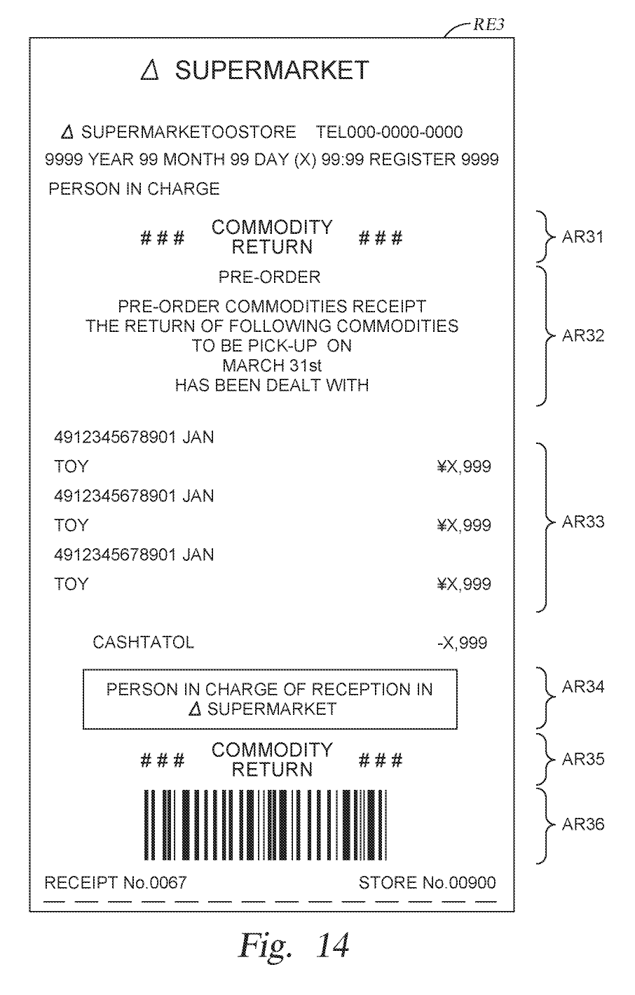

FIG. 14 is a diagram illustrating an example of a cancellation receipt RE3. FIG. 14 shows a form of the cancellation receipt RE3, and a part of the information shown is different from the actual one.

Areas AR31 and AR35 in the cancellation receipt RE3 are highlighted to emphasize that the voucher is a certificate of the cancellation of the pre-order. In an embodiment, as the form of the cancellation receipt RE3, a general form of a commodity return receipt for certifying return of the purchase commodity is used, and the characters shown in the areas AR31 and AR35 shows the label “commodity return”. An area AR32 of the cancellation receipt RE3 indicates that the pre-order to receive the commodity on March 31st which is the designated pick-up date is canceled. An area AR33 of the cancellation receipt RE3 shows the content of the cancellation list, i.e., the catalog of commodities whose pre-order is canceled. An area AR34 of the cancellation receipt RE3 indicates a signature column for signing by a store clerk who receives the pre-order by operating the POS terminal 10. An area AR36 of the cancellation receipt RE3 indicates a barcode for journal search.

After that, the processor 11 issues the transaction receipt in Act 18 in the same way as that in the information processing in the case of the reception of the pre-order described above. However, since the transaction at this time is a cancellation of the pre-order, the transaction receipt at this time indicates the cancellation of the pre-order.

In Act 35, the processor 11 enables the printer 17 to issue a cancellation duplicate receipt. The cancellation duplicate receipt is kept in the retail store as a certificate showing that the pre-order is canceled. Specifically, the processor 11 generates an image indicating the pre-order result such as the pick-up date and the content of the commodity list, and instructs the printer 17 to print the image.

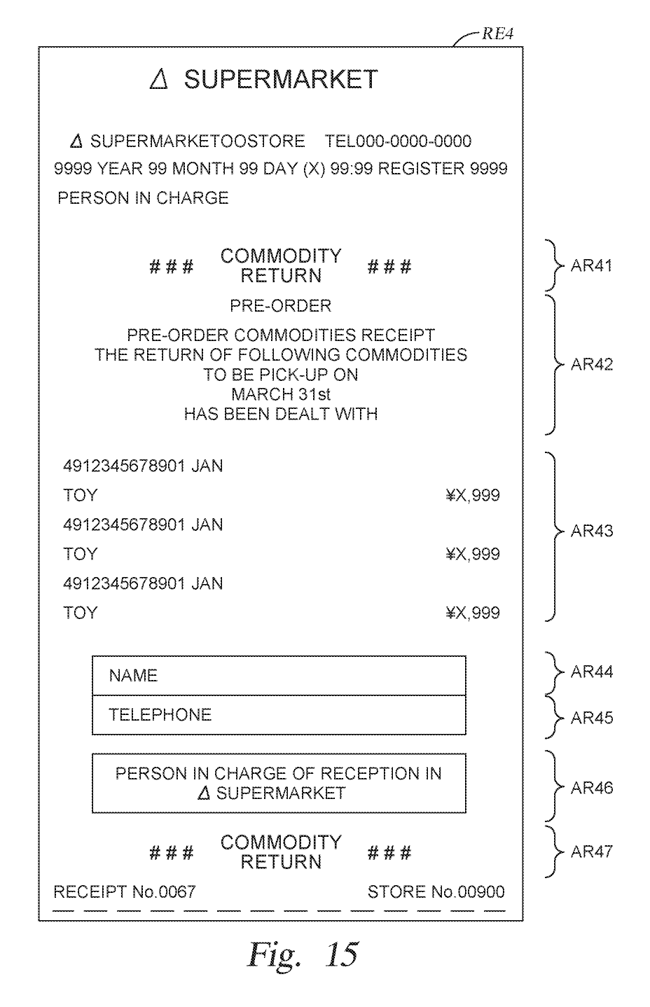

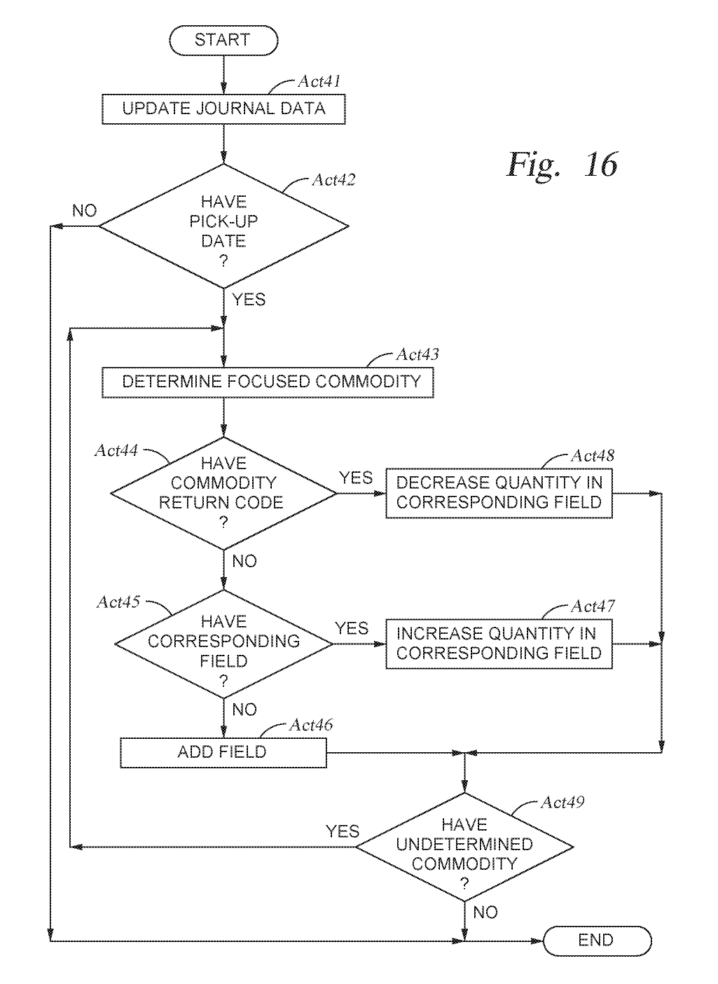

FIG. 15 is a diagram illustrating an example of a cancellation duplicate receipt RE4. FIG. 15 shows a form of the cancellation duplicate receipt RE4, and a part of the information shown is different from the actual one.

Areas AR41 and AR47 in the cancellation duplicate receipt RE4 are highlighted to emphasize that the voucher is a certificate of the cancellation of the pre-order. An area AR42 of the cancellation duplicate receipt RE4 indicates that the pre-order to receive the commodity on March 31st which is the designated pick-up date is canceled. An area AR43 of the cancellation duplicate receipt RE4 shows the content of the cancellation list, i.e., the catalog of commodities whose pre-order is canceled. An area AR44 of the cancellation duplicate receipt RE4 indicates a signature column for signing by a customer who cancels the pre-order. An area AR45 of the cancellation duplicate receipt RE4 indicates an entry column for a customer who cancels the pre-order to enter the telephone number as a contact address. An area AR46 of the cancellation duplicate receipt RE4 indicates a signature column for signing by a store clerk who cancels pre-order by operating the POS terminal 10.

In Act 36, the processor 11 transmits the transaction information to the POS server 20 from the communication interface 18 through the communication network 30. For example, the transaction information may be the same as the information that is transmitted from the existing POS terminal to the POS server for sales management in the existing POS server. However, the processor 11 includes the pick-up date in association with each commodity code in the transaction information. As a result, by transmitting the transaction information, the POS server 20 is notified of the cancellation of the pre-order. The processor 11 includes a predetermined commodity return code indicating that the commodity is a returned commodity in the transaction information. The processor 11 may store the transaction information in the main memory 12 or the auxiliary storage device 13, and transmit it at a predetermined timing.

After that, the processor 11 terminates the information processing shown in FIG. 13.

If the transaction information, which is transmitted from the POS terminal 10 by the processor 11 executing the processing in Act 20 in FIG. 5 or the Act 36 in FIG. 13, is transmitted to the POS server 20 via the communication network 30, the transaction information is received by the communication interface 24. If the transaction information relating to the normal sales that are not the pre-order sales is transmitted from the POS terminal 10 to the POS server 20 via the communication network 30, the transaction information is similarly received by the communication interface 24. Then, if the transaction information is received in this way, the processor 21 of the POS server 20 starts the information processing shown in FIG. 16. The processor 21 executes the information processing described below by executing the information processing program stored in the main memory 22 or the auxiliary storage device 23.

FIG. 16 is a flowchart depicting the information processing by the processor 21.

In Act 41, the processor 21 updates the journal data so as to include the content of the transaction indicated by the received transaction information.

In Act 42, the processor 21 determines whether or not the received transaction information includes the pick-up date. Then, if the pick-up date is included, the processor 21 determines Yes in Act 42 and proceeds to the processing in Act 43.

In Act 43, the processor 21 determines one of the commodities indicated in the transaction information as a focused commodity.

In Act 44, the processor 21 confirms whether or not the commodity return code is included in the transaction information. If the commodity return code is not included, the processor 21 determines No in Act 44, and proceeds to the processing in Act 45. In other words, if the transaction information transmitted in Act 20 shown in FIG. 5 is received, the processor 21 proceeds to the processing in Act 45.

In Act 45, the processor 21 determines whether or not the field F22 satisfying the following two conditions exists.

(1) Field F22 in which the commodity code of the focused commodity is included in the data record DR2 indicated in the field F21

(2) Field F22 in which the pick-up date contained in the received transaction information is indicated as the pick-up date.

Then, if the corresponding field F22 does not exist, the processor 21 determines No in Act 45, and proceeds to the processing in Act 46.

In Act 46, the processor 21 adds a filed F22 in which the pick-up date contained in the received transaction information and a quantity of the focused commodities indicated by the received transaction information to the data record DR2 in which the commodity code of the focused commodity is shown in the field F21. The processor 21 adds a new data record DR2 to the pre-order sales data 23b if there is no data record DR2 in which the commodity code of the focused commodity is shown in the field F21. It is assumed that in the data record DR2, the commodity code of the focused commodity is shown in the field F21, and the pick-up date contained in the received transaction information and the quantity of the focused commodities are shown in the field F22.

On the other hand, if the corresponding field F22 exists, the processor 21 determines Yes in Act 45, and proceeds to the processing in Act 47.

In Act 47, the processor 21 increases the quantity shown in the corresponding field F22 by the quantity of the focused commodities shown in the received transaction information.

If the commodity return code is included in the transaction information, the processor 21 determines Yes in Act 44, and proceeds to the processing in Act 48. In other words, if the transaction information transmitted in Act 36 shown in FIG. 13 is received, the processor 21 proceeds to the processing in Act 48.

In Act 48, the processor 21 decreases the quantity shown in the corresponding field F22 by the quantity of the focused commodities contained in the received transaction information.

As described above, the processor 21 totalizes the number of pre-ordered commodities for each pick-up date by the processing in Act 46, Act 47 and Act 48. Thus, the processor 21 executes the information processing based on the information processing program, and in this way, the computer having the processor 21 as the central part functions as a totalizing module for performing the above-described totalization.

Upon completion of any one of the processing in Act 46, Act 47 and Act 48, the processor 21 proceeds to the processing in Act 49.

In Act 49, the processor 21 determines whether or not there is a commodity which has not been determined as the focused commodity among the commodities indicated by the transaction information. If there is a corresponding commodity, the processor 21 determines Yes in Act 49, and repeats the processing subsequent to Act 43 in the same way as described above. At this time, in Act 43, the processor 21 determines the commodity that has not yet been determined as the focused commodity as a new focused commodity. In other words, the processor 21 performs the processing in Act 46, Act 47 or Act 48 for each of the commodities indicated by the transaction information. If all the commodities indicated by the transaction information are determined as the focused commodity, the processor 21 determines No in Act 49 and terminates the information processing.

If the received transaction information does not include the pick-update, the processor 21 determines No in Act 42 and terminates the information processing without executing the processing in Act 43 to Act 49. In other words, the processor 21 does not update the pre-order sales data 23b if the received transaction information relates to the normal sales which are not the pre-order sales.

In this manner, the POS server 20 manages the total number of pre-orders in each pick-up date for the pre-ordered commodity, and does not manage who makes the pre-order or when the pre-order is made in the pre-order sales. If the POS server 20 is a headquarters server, generally, a store code for identifying a retail store where the POS terminal 10 is installed is included in the transaction information. In such a case, the POS server 20 may manage the pre-order sales data 23b in association with the store code.

As described above, according to the POS terminal 10, for example, the commodity which is a reservation sales target is determined by an operation by the store clerk which is the same as the normal purchase registration. According to the POS terminal 10, the pick-up date of the above commodity is determined by the operation by the store clerk. According to the POS terminal 10, the pre-order receipt RE1 for the customer and the pre-order duplicate receipt RE2 for the retail store, which show the commodity and the pick-up date, are issued, respectively. Therefore, the customer can prove that he/she is the person who makes pre-order by presenting the pre-order receipt RE1 in the retail store. By comparing the pre-order receipt RE1 presented by the customer with the pre-order duplicate receipt RE2, the store clerk in the retail store can confirm that the pre-order is correctly made. Therefore, there is no need for the store clerk to fill in the pre-order book, and a failure that the management of the pre-order cannot be correctly performed due to an entry mistake at that time does not occur. As a result, it is possible to easily and properly receive and manage the pre-order sales of the commodity.

The POS terminal 10 can also perform the normal purchase registration and the checkout processing like an existing POS terminal in addition to an operation of determining the pick-up date, an operation of issuing the pre-order receipt RE1 and the pre-order duplicate receipt RE2 and an operation of containing the pick-up date in the transaction information. In other words, the POS terminal 10 can be realized by a simple modification of the use of the existing POS terminal without great change.

According to the POS terminal 10, it is determined whether the designated commodity is appropriate as a pre-order target commodity or whether the designated pick-up date is appropriate as the pick-up date of the pre-order target commodity. If it is determined that the appropriateness is not satisfied, the pre-order receipt RE1 and the pre-order duplicate receipt RE2 are not issued. Therefore, it is possible to prevent a pre-order for designating an inappropriate commodity or an inappropriate pick-up date from being received.

According to the POS terminal 10, if it is detected that the commodity or the pick-up date is inappropriate, the fact is notified to the store clerk through the commodity error screen SC3, the period error screen SC4 or the pick-up date error screen SC5. For this reason, the store clerk can know that the pre-order cannot be received, and it is possible to promptly take measures for receiving an appropriate pre-order.

According to the POS terminal 10, for example, the commodity which is a pre-order cancellation target is determined by an operation by the store clerk which is the same as the normal commodity return registration. According to the POS terminal 10, the pick-up date of the above commodity is determined by the operation by the store clerk. According to the POS terminal 10, the cancellation receipt RE3 for the customer and the cancellation duplicate receipt RE4 for the retail store, which show the commodity and the pick-up date, are issued, respectively. Therefore, the customer can prove that the pre-order is canceled using the cancellation receipt RE3. If the customer presents the cancellation receipt RE3 relating to the canceled pre-order, the store clerk can confirm that the pre-order is canceled by comparing the cancellation receipt RE3 with the cancellation duplicate receipt RE4. Therefore, there is no need for the store clerk to manage the cancellation by leaving a note for the pre-order duplicate receipt RE2, and a failure that the management of the pre-order cannot be correctly performed due to an entry mistake or an entry omission at that time does not occur.

The POS terminal 10 can also perform the normal commodity return processing like an existing POS terminal in addition to an operation of determining the pick-up date, an operation of issuing the cancellation receipt RE3 and the cancellation duplicate receipt RE4 and an operation of containing the pick-up date in the transaction information. In other words, the POS terminal 10 can be realized by a simple modification of the use of the existing POS terminal without great change.

According to the POS terminal 10, it is determined whether the designated commodity is appropriate as a commodity which is the pre-order cancellation target or whether the designated pick-up date is appropriate as the pick-up date of the commodity which is the pre-order cancellation target. If it is determined that the appropriateness is not satisfied, the cancellation receipt RE3 and the cancellation duplicate receipt RE4 are not issued. Therefore, it is possible to prevent a pre-order cancellation for designating an inappropriate commodity or an inappropriate pick-up date from being received.

According to the POS system 100, it is assumed that the confirmation of the pre-order in the retail store is performed based on the pre-order receipt RE1 and the pre-order duplicate receipt RE2 as described above, and in the POS server 20, the total number of pre-orders in each pick-up date is managed in the pre-order sales data 23b for managing the pre-order, and the details such as who makes the pre-order, when the pre-order is made or the like are not managed. Therefore, compared to a case of managing the above details such as who makes the pre-order, when the pre-order is made or the like, the data amount of the pre-order sales data 23b can be kept small. Then, it is possible to easily determine a type of the commodity, the pick-up date and the pre-ordered quantity of the commodities from the pre-order sales data 23b, and it is possible to facilitate ordering work of a pre-ordered commodity.

In this embodiment, the following various modifications can be made.

The printer 17 may not be included in the POS terminal 10, and it may be a printer device or the like externally attached to the POS terminal 10.

Instead of at least one of the pre-order receipt RE1 and the pre-order duplicate receipt RE2, the information shown in them may be stored in a portable storage medium. In this case, the storage medium for storing the information functions as a pre-order receipt, and a device that writes the information to the storage medium corresponds to an issuing device.

The aforementioned embodiments are applicable to a device different the POS terminal, such as a commodity registration apparatus which has a function of performing the commodity registration and does not have function of performing the checkout processing, which has a function of the pre-order reception device, or by an independent device as the pre-order reception device.

The aforementioned embodiments are applicable to a device and a system for receiving and managing the pre-order relating to a service to be provided from a provider to a provided person for free based on the pre-order in addition to the pre-order sales.

The processor 11 may provide different periods such as in units of hour, week, month or the like as the provision period instead of a provision date which is a period in units of day.

Apart of the above-described information processing performed by the processors 11 and 21 may be omitted. For example, one or two of the processing in Act 6, Act 8, and Act 10 in FIG. 4 may be omitted. Likewise, one or two of the processing in Act 6, Act 31, Act 10 in FIG. 13 may be omitted. Incidentally, the flow proceeds to the processing performed when Yes is determined in the omitted processing from the processing prior to the omitted processing.

A part or all of the functions realized by the processors 11 and 21 through the information processing can be realized by hardware which executes the information processing not based on the program, such as the logic circuit or the like. Each of the above-described functions can also be realized by combining software control with the hardware such as the above logic circuit.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A pre-order processing device, comprising:
an input device;
a scanner;
a printer; and
a processor configured to control the printer to print a pre-order receipt for a pre-order item according to inputs made on the input device, a commodity code read by the scanner, and information about the pre-order item stored in a database.

2. The device according to claim 1, wherein the inputs include a date for pick-up of the pre-order item and the processor determines whether the pre-order item identified by the commodity code will be ready for pick-up on the input date based on an available time period of the pre-order item, which is stored in the database.

3. The device according to claim 2, wherein the processor controls the printer to print the pre-order receipt when the pre-order item will be ready for pick-up on the input date.

4. The device according to claim 1, wherein
the processor is configured to perform a checkout process on the identified commodity when the identified commodity will be ready for pick-up on the input date.

5. The device according to claim 1, further comprising:
a display, wherein
the processor is configured to control the display to show an error when the pre-order item will not be ready for pick-up on the input date.

6. The device according to claim 1, wherein the database stores a valid pre-order time period for each of a plurality of commodities that are available for pre-order.

7. The device according to claim 6, further comprising:
a display, wherein
the processor is configured to control the display to show an error when the commodity code that is read is for a commodity that is not available for pre-order.

8. The device according to claim 6, further comprising:
a display, wherein
the processor is configured to control the display to show an error when the present date does not fall within the valid pre-order time period.

9. The device according to claim 1, further comprising:
a network interface, wherein
the processor controls the network interface to transmit transaction information about the pre-order item to a data management apparatus when the pre-order receipt is printed.

10. A pre-order processing method, comprising:
acquiring inputs made on an input device, including a date for pick-up of a pre-order item, and a commodity code for the pre-order item read by a scanner;
accessing a database storing information about the pre-order item; and
printing a pre-order receipt for the pre-order item according to the inputs made on the input device, the commodity code read by the scanner, and the information about the pre-order item stored in the database.

11. The method according to claim 10, further comprising:
determining if the pre-order item identified by the commodity code will be ready for pick-up on the input date based on an available time period of the pre-order item, which is stored in the database.

12. The method according to claim 11, wherein the pre-order receipt is printed when it is determined that the pre-order item will be ready for pick-up on the input date.

13. The method according to claim 11, further comprising:
performing a checkout process on the identified commodity when it is determined that the identified commodity will be ready for pick-up on the input date.

14. The method according to claim 11, further comprising:
displaying an error when the pre-order item will not be ready for pick-up on the input date.

15. The method according to claim 10, wherein the database stores a valid pre-order time period for each of a plurality of commodities that are available for pre-order.

16. The method according to claim 15, further comprising:
displaying an error when the commodity code that is read is for a commodity that is not available for pre-order.

17. The method according to claim 15, further comprising:
displaying an error when the present date does not fall within the valid pre-order time period.

18. The method according to claim 10, further comprising:
transmitting transaction information about the pre-order item to a data management apparatus when the pre-order receipt is printed.
